(19) United States
(12) Patent Application Publication
(10) Pub. No.: US 2002/0057169 A1
(43) Pub. Date: May 16, 2002

(54) INDUCTIVE COMPONENT COMPRISING A ROD-SHAPED CORE

(76) Inventors: MANFRED ALBACK, AACHEN (DE); EUGEN DE MOL, EINDHOVEN (NL); HARRY MICHIELS, VORSTENBOSCH (NL)

Correspondence Address: JACK E HAKEN, CORPORATE PATENT COUNSEL, US PHILIPS CORPORATION, 580 WHITE PAINS ROAD, TARRYTOWN, NY, 10591

(21) Appl. No.: 09/400,759

(22) Filed: Sep. 21, 1999

(30) Foreign Application Priority Data
Sep. 22, 1998 (DE) 19843415.4

(51) Int. Cl. H01F 27/30

(52) U.S. Cl. 336/198

(57) ABSTRACT

The invention relates to an inductive component (1) comprising a rod-shaped core (2) and a winding body (3) in which the layers of the current turns (4) enveloping the axis of the rod-shaped core are embedded.

In order to counteract heating of the inductive component, it is proposed that the width of the innermost layer of current turns is made smaller than the length of the rod-shaped core, and that the width of the layers of current turns increases from the inside outwards.

The invention relates to an inductive component comprising a rod-shaped core and a winding body in which the layers of the current turns enveloping the axis of the rod-shaped core are embedded.

It is known to provide coils having a rod-shaped core and transformers having a rod-shaped core with a winding body enveloping said rod-shaped core, said winding body having a bed for accommodating the turns of a current winding. The current turns thus embedded are concentrically arranged about the axis of the rod-shaped core. The layers of current turns are laterally fixed by the walls of the bed of the winding body. In the manufacture of such an inductive component, the winding body is slid onto the rod-shaped core, whereafter the current turns are provided. An example of a known coil having a rod-shaped core is shown in FIG. 5. Such inductive components are faced with the problem of overheating during operation at high alternating-current frequencies, which occur, for example, when they are used in ballast-circuits of gas-discharge lamps.

It is an object of the invention to counteract heating of the inductive component.

This object is achieved in that the width of the innermost layer of current turns is smaller than the length of the rod-shaped core, and in that the width of the layers of current turns increases from the inside outwards.

In the manufacture of the inductive component, the bed of the winding body is filled with current turns from the inside outwards, thereby forming the layers of current turns. The width of the layers of current turns is to be measured in a direction parallel to the axis of the rod-shaped core. The attained reduction in dissipated heat is based on the fact that just in the outer regions (i.e. the regions closest to the ends of the rod-shaped core) of the innermost (i.e. situated closest to the rod-shaped core rod) layers of current turns a high magnetic field strength is produced when current flows through the current turns, which high magnetic field strength leads to high eddy-current losses (“proximity” losses). In the inductive component in accordance with the invention, the current turns are concentrated in regions where the magnetic field strength is smaller. At the same time, the ends of the rod-shaped core can be left clear by suitably embodying the winding body. In these regions, the rod-shaped core can emit the dissipated heat directly to the surrounding air, which additionally counteracts heating of the component. The winding body is preferably embodied so as to be a synthetic resin injection-molded part, so that winding bodies having any desired bed profile can be economically mass-produced. In addition, the component in accordance with the invention enables a higher inductance to be obtained with the same number of current turns.

The winding body can be embodied in various ways. If, viewed from the side of the current turns, the side faces of the bed of the winding body exhibit a convex profile, then a very high dissipated heat-reduction is achieved. In other embodiments of the winding body, the side faces of the bed of the winding body are in the shape of a truncated outer surface, which leads to a simplification of the manufacturing process by virtue of the simple profile of the bed of the winding body; the side faces of the bed of the winding body may alternatively exhibit a concave profile, viewed from the side of the current turns.

If the side faces of the bed of the winding body are provided with a plurality of openings, the emission of dissipated heat to the surrounding air is improved, which additionally helps to decrease the operating temperature of the component.

The invention also relates to a winding body of the type described hereinabove.

The inductive component can suitably be embodied so as to be a coil or a transformer.

These and other aspects of the invention will be apparent from and elucidated with reference to the embodiments described hereinafter.

In the drawings:

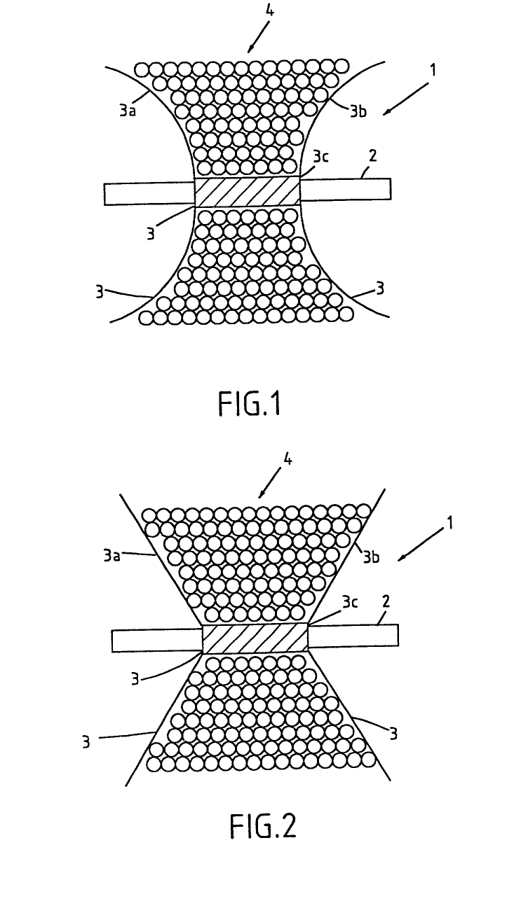

FIGS. 1 to 3 show inductive components in accordance with the invention comprising different winding bodies,

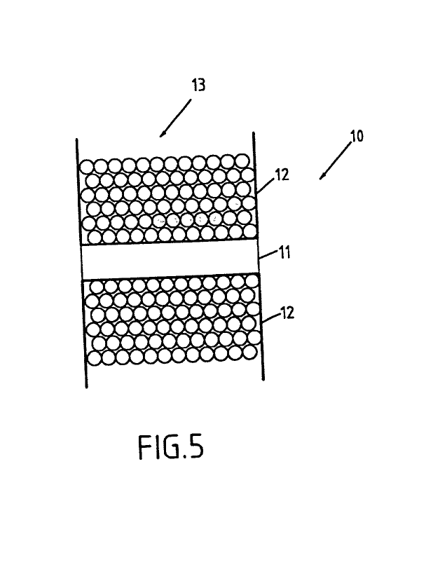

FIG. 4 is a side view of a winding body in accordance with the invention, and

FIG. 5 shows an inductive component in accordance with the state of the art.

The inductive component 1 shown in FIG. 1 comprises a rod-shaped core 2 which supports a winding body 3. In this case, the inductive component 1 is embodied so as to be a coil, however, the principle in accordance with the invention can also readily be applied to transformers. The winding body 3 forms a bed in which a winding with current turns 4 is embedded. The winding body 3 is composed of two shells 3a and 3b, which are connected to a sleeve 3c which is slid round the rod-shaped core 2. The current turns 4 form layers of current turns whose width is determined by the profile of the bed of the winding body, which in turn depends upon the shape of the shells 3a and 3b of the winding body 3. The width of the innermost layer of current turns is smaller than the length of the rod-shaped core 2. The width of the layers of current turns increases from the inside outwards. The increase of the width of the layers of current turns depends on the shape of the side faces of the winding-body bed, which side faces are formed by the shells 3a and 3b. In FIG. 1, the side faces of the bed of the winding body, i.e. the shells 3a and 3b, exhibit a convex profile, viewed from the side of the current turns 4. The inductive component 1 thus formed heats up to a much smaller degree during alternating-current operation than customary inductive components with a rod-shaped core, because the eddy current losses are reduced and, in addition, the exposed ends of the rod-shaped core 2 can give off heat to the ambient air.

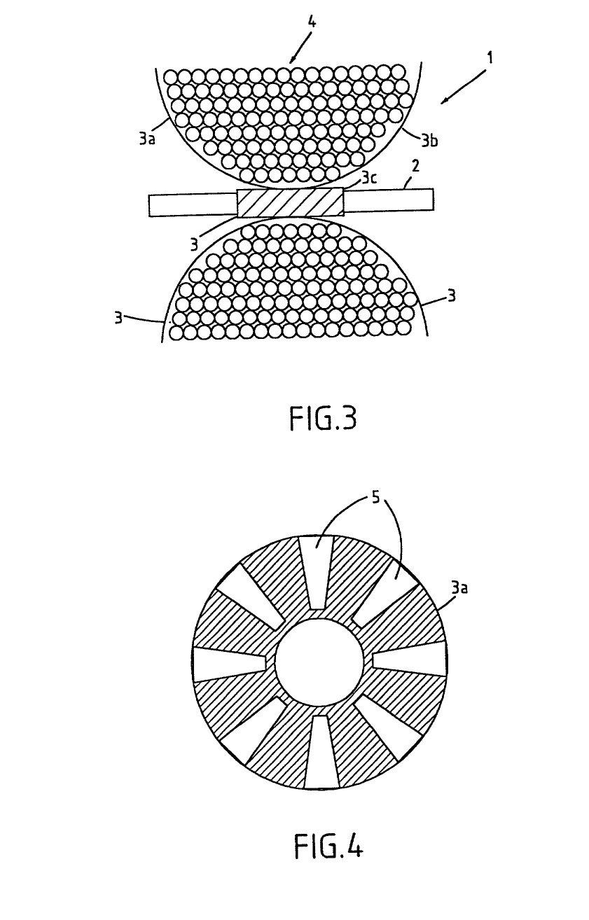

FIGS. 2 and 3 show embodiments of the inductive component 1 comprising different modifications of the winding body 3. In the case of the inductive component 1 shown in FIG. 2, the side faces of the bed of the winding body are in the shape of an outer surface of a truncated cone. The side faces and hence the shells 3a and 3b are not rounded. In FIG. 3, however, the side faces of the bed of the winding body exhibit, viewed from the side of the current turns 4, a concave profile. Viewed from the side of the current turns, the shells 3a and 3b are rounded outward.

FIG. 4 is a side view of the winding body 3, viewed from an end of the rod-shaped core. The shell 3a and hence the corresponding side wall of the bed of the winding body exhibits openings 5 which enable an improved heat dissipation to the ambient air. The undepicted shell 3b is embodied in the same manner.

Preferably, the winding body 3 is made from a synthetic resin and manufactured by means of injection molding, so that any desired profile shapes of the bed of the winding body can be economically mass-produced. The rod-shaped core 2 is made, in particular, from ferrite although other soft-magnetic materials can alternatively be used for the rod-shaped core.

FIG. 5 shows a coil 10 having a rod-shaped core in accordance with the state of the art. A winding body 12 is slid onto a rod-shaped core 11, said winding body serving to accommodate current turns 13. The bed of the winding body is rectangular in profile. The winding body envelopes the rod-shaped core 11 throughout the length thereof.

1. An inductive component (1) comprising a rod-shaped core (2) and a winding body (3) in which the layers of current turns (4) enveloping the axis of the rod-shaped core are embedded, characterized in that the width of the innermost layer of current turns is smaller than the length of the rod-shaped core, and that the width of the layers of current turns increases from the inside outwards.

2. An inductive component as claimed in claim 1, characterized in that the side faces (3a, 3b) of the bed of the winding body exhibit a convex profile, viewed from the side of the current turns (4).

3. An inductive component as claimed in claim 1, characterized in that the side faces (3a, 3b) of the bed of the winding body are in the shape of an outer surface of a truncated cone.

4. An inductive component as claimed in claim 1, characterized in that the side faces (3a, 3b) of the bed of the winding body exhibit a concave profile, viewed from the side of the current turns (4).

5. An inductive component as claimed in any one of claims 1 to 4, characterized in that the side faces (3a, 3b) of the bed of the winding body have a plurality of openings (5).

6. Winding body (3) for an inductive component with a winding body bed for accommodating layers of concentric current turns (4) and the width of the layers (4) increasing from the inside outwards.
